(19) United States
(12) Patent Application Publication
(10) Pub. No.: US 2015/0363776 A1
(43) Pub. Date: Dec. 17, 2015

(54) System and Method for Managing a Payment Transaction

(71) Applicant: SecuresIT, Wilmington, DE (US)

(72) Inventors: Carlos J. Gomez, Mooresville, NC (US); James D. Hunter, Orange, CA (US)

(73) Assignee: SECURESIT, Wilmington, DE (US)

(21) Appl. No.: 14/742,022

(22) Filed: Jun. 17, 2015

Related U.S. Application Data
(60) Provisional application No. 62/013,411, filed on Jun. 17, 2014.

(51) Int. Cl. G06Q 20/40

(52) U.S. Cl. CPC G06Q 20/40

(57) ABSTRACT

An improved system and method for managing payment transactions whereby a paying entity and payment receiving entity perform the payment transaction using a transaction server of a payment management service provider that receives a keyword and performs a sequence of steps corresponding to a transaction scenario of a plurality of transaction scenarios corresponding to the keyword. As part of the sequence of steps the transaction server calls a phone of the paying entity to receive payment information that is provided using a keypad or voice commands. The transaction server provides the payment information to a payment processing service provider to authorize the transaction and provides transaction authorization information received from the payment processing service provider to the paying entity and payment receiving entity.

### RELATED APPLICATIONS

This application claims the benefit under 35 USC 119(e) of provisional application 62/013,411, titled “Platform-Independent, Secure, Encrypted, Data Exchange and Independent Payment System and Method”, filed Jun. 17, 2014, by Gomez et al, which is incorporated by reference herein in its entirety.

### FIELD OF THE INVENTION

The present invention relates generally to electronic transfer of funds during online purchases. More particularly, the present invention relates to electronic transfer of funds during online purchases managed by a transaction server that performs sequences of steps corresponding to a transaction scenario of a plurality of transaction scenarios as determined by a keyword corresponding to a transaction.

### BACKGROUND OF THE INVENTION

Payment by credit cards has become problematic in recent years. Various electronic wallets and other forms of payment are available to consumers who wish to shop online Funds are in banks, requiring procedures and personal presence to obtain cash. Credit cards are only part of the solution, and each is accepted at only certain ones of the establishments. Their data may be compromised as it is stored and passed about over the Internet.

Moreover, one needs a merchant account on one side of the transaction (the seller), and a credit card reader and software application on the other side (the buyer). The incompatibility of systems is just one of the issues resulting. Security of credit card information provided to merchants is also in question.

Therefore, an improved payment system and method is needed.

### SUMMARY OF THE INVENTION

Briefly, the present invention is an improved system and method for managing a payment transaction. A paying entity (e.g., a user) and payment receiving entity (e.g., a client) perform the payment transaction using a third party payment management service provider authorized by the client and the user to manage the payment transaction. A transaction server of the third party payment management service provider receives a keyword and performs a sequence of steps corresponding to a transaction scenario of a plurality of transaction scenarios corresponding to the keyword. As part of the sequence of steps the transaction server calls a phone of the user to receive payment information that is provided by the user using a keypad or voice commands. The transaction server provides the payment information to a payment processing service provider to authorize the transaction and provides transaction authorization information received from the payment processing service provider to the user and to the client.

### BRIEF DESCRIPTION OF THE FIGURES

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 depicts an exemplary system for managing a transaction in accordance with the invention; and

FIG. 2 depicts an exemplary method for managing a transaction in accordance with the invention.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be thorough and complete and will fully convey the scope of the invention to those skilled in the art.

The present invention relates to an improved system and method for managing a transaction, for example, using a Software-as-a-Service (SaaS) platform that offers services embodying various aspects of the present invention. SaaS is a software licensing and delivery model in which software is licensed on a subscription basis and is hosted centrally or distributed. The SaaS can offer a wide variety of services to subscribers including, but not limited to, health, financial, cyber-security, industrial, transportation, manufacturing, construction services. The SaaS platform comprises an Application/Web Server Cluster of one or more servers, which communicates with a Database Server Cluster of one or more databases. The SaaS platform can be used to provide application services offered to multiple service subscribers. For example, a first and a second service subscriber can each offer independent application services to individuals or participants in an institution or organization over the Internet via a firewall Cluster of one or more firewalls. One such SaaS can be implemented on a cloud to serve various industries.

A paying entity (a user) and a payment receiving entity (a client or subscriber) perform a payment transaction without the user providing payment information to the client or subscriber. Instead, a transaction server of a payment management service provider authorized by a client to manage a transaction calls the phone of a user that then uses the phone's keypad or voice commands to provide payment information to the transaction server. I one embodiment, such commands are alphanumeric, image, voice or video commands generated by a messaging service, e.g., Short Messaging Service (SMS). Such service can be a pre-loaded or downloaded messaging application resident in a user device. The messaging application executed by a user device processor that manages transport of message over logical links and physical channels via a messaging transport protocol. The transaction server then provides the user's payment information to and otherwise interfaces with a payment processing service provider to manage the payment transaction. The transaction server then provides transaction authorization information received from the payment processing service provider to the client and to the user.

A payment receiving entity is herein referred to as a client because the payment receiving entity is typically a client of the payment management service provider that pays the payment management service provider to manage the client's transactions in accordance with client specific transaction requirements, where a client specifies a keyword corresponding to a sequence of steps to be performed by a transaction server as part of a transaction scenario that the client can specify independent of other transaction scenarios specified by other clients of the payment management service provider. A paying entity is herein referred to as a user because the paying entity is typically a user of a product or service being provided by the payment receiving entity. As such, the payment management service provider manages a transaction between a client of the payment management service provider and a user of the client's product or service.

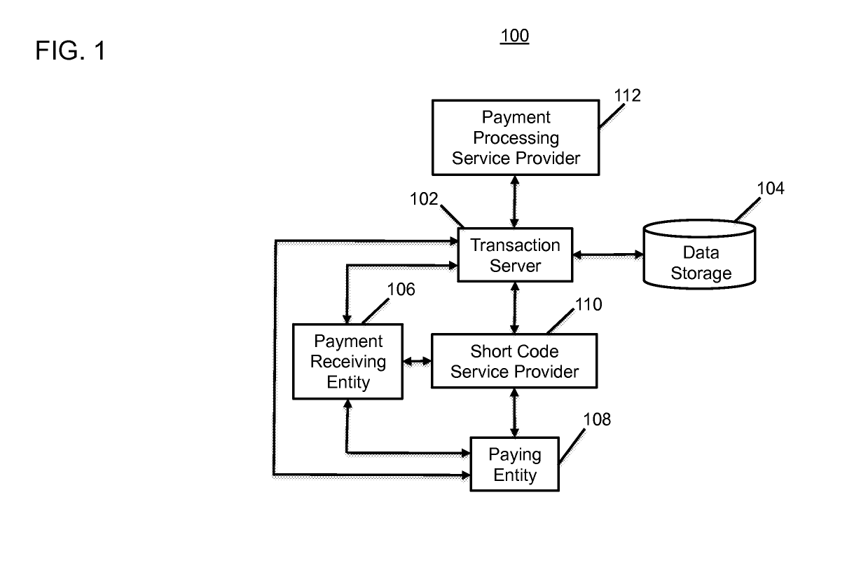

FIG. 1 depicts an exemplary system 100 for managing a payment transaction. Referring to FIG. 1, the system 100 includes a transaction server 102, a data storage 104, a client (i.e. payment receiving entity) 106, a user (i.e., a paying entity) 108, a short code service provider 110, and a payment processing service provider (e.g., credit card company or bank) 112. As depicted, the short code service provider 110 is an automated process running on a computer separate from the computer on which the transaction server 102 (another automated process) is running but the two automated processes could alternatively reside on the same computer. The transaction server manages a plurality of transaction scenarios where a given transaction scenario can be unique to a given client. Specifically, each transaction scenario has a corresponding sequence of steps for the transaction server to process that are stored in the data storage 104 along with a corresponding keyword used to identify and initiate a given transaction scenario, whereby the steps to perform and the keyword are determined by a respective client.

Because the steps performed for a given transaction by the transaction server are configurable, the transaction server is capable of implementing all sorts of transaction scenarios involving many different types of clients and many different types of users. For example, a transaction scenario might involve a municipal court of a city collecting monies relating to parking tickets or a sports fan at a sporting event purchasing an item from a web enabled menu of a food vendor selling food at the event. Generally, most any situation involving a paying entity and a payment receiving entity can have a corresponding transaction scenario involving a sequence of steps for the transaction to perform that are customizable to the situation. A transaction can be very simple where it merely involves gathering payment information and interfacing with a payment processing service provider.

A given payment transaction is initiated when a keyword is provided to the transaction server 102, which can happen in various ways.

Under a first arrangement, a user 108 receives from a merchant a short code and a phrase (e.g., ticket) that acts as an invoice. As such, the phrase becomes a keyword. The short code and/or keyword might be received via mail, email, fax, text message (SMS and/or MMS), voice message, an advertisement on television, in a newspaper, in a magazine, or on a billboard, via some offer provided on the Internet, or by any other method. The user starts the process of payment by texting the keyword to a short code (phone number). This text message is handled by a short code service provider (i.e., telephone carrier company, phone company, telecommunications company) 110 that handles short codes, which then sends a command (or keyword) to another telephone carrier company service where a server computer is connected to the telecommunication network, and on which the transaction server software 102 resides.

Under a second arrangement, a user 108 contacts a client 106 that contacts the transaction server 102, where the client 106 provides a keyword and additional information (i.e., user phone number, amount of transaction, a description of the transaction, etc.).

Under a third arrangement, a user 108 contracts the transaction server 102 directly via a phone number, where the phone number is treated as the keyword.

Under a fourth arrangement, a user 108 sends a keyword to a short code received by a short code service provider 106 that passes on the keyword to a client 108 that can pass on the keyword to the transaction server 102, or the client may perform certain functions and provide the same or a different keyword to the transaction server 102.

The transaction server 102 is connected to communicate over a communications line with transfers of data. By being a dial up “conversation,” the transaction is random in time, location, duration, parties, and more. All of the protocols of audio and data transmission are automatically invoked, including error checking, encryption, and the like with no intervention needed by the user 108 or the transaction server 102.

The transaction server 102 will receive the keyword in a text message and treat it as one of several command types that it may look up in a data storage 104 (i.e., database or other table). The server 102 then determines (interprets) what needs to be done based on the keyword that was sent and received, based on a corresponding entry in the data storage 104 or otherwise corresponding to the text message content. Specifically, the server software conducts a search of the data storage 104 that may be as simple as a look up table entry in a database to find a sequence of all the steps needed to process a given keyword. Thus, just as an object in object oriented programming, the keyword that was texted (and even the phone short code number called) may provide information for what is being done, how it is to be done, and so forth. Any and every keyword received from a caller (i.e., user, client, customer) may have its own variation on the number of steps and the content of each step to be executed.

A pointer then simply walks through the commands, parsing as little or as much as needed to loop through all the steps listed and identifying them to a processor, which will then process them one at a time.

A transaction scenario might be as simple as “make a voice phone call to the user to start the secure process” and “provide payment information to payment processing service provider”, or as complex as assembling all the details and sending a secure request to a credit card processing company (i.e., payment processing service provider) 112 to authorize the transaction. Other processing steps may involve handling redemption points, providing discounts or upgrades, providing product location services, providing product information, performing analysis, sending a confirmation email, and the like. Generally, the various steps that make up various transaction scenarios can be tailored to meet unique payment transaction requirements of all sorts of payment receiving entities such as restaurants, theme parks and attractions, expositions and conferences, traveling shows, concerts, and live entertainment, sporting events, hotels and resorts, theaters, taxies, municipalities and governments, charities and non-profit organizations, on-line stores, and the like.

When the transaction server calls a user to get payment information, all information is gathered from the user using prompts by recorded voice, live voice, synthesized voice, or displayed text directed to the keypad on the phone of the user, where the user may be a “caller” who initiated the text to the designated number (i.e., short code), a user that contacted a client, or a user that called the transaction server directly. The user may input by keypad entry or voice commands whatever information is needed in response to the pre-recorded requests, or by computer generated requests “received from the server 102 during the “call.”

Each client 108 may have its own set of steps to be performed. They are not mixed with each other. When all the steps have been performed, the credit card company 112 makes its payment and the credit card information need not ever be stored in the server computer 102 used to manage authorization of the payment.

The server 102 never needs to access or store credit card information, which is only received from the customer (i.e., user) 108 and passed on to the payment processing service provider 112 to be processed as it would be if provided directly to the payment processing service provider 112 by the user 108. At the end of the payment transaction, the server 102 may send an MMS “Thanks” message, confirmation number, or the like to the phone of the user 108.

All credit card processing is done inside the computer hosting the transaction server 102 and no credit card information leaves that computer except to be sent securely to the credit card processing company (i.e., payment processing service provider) 112.

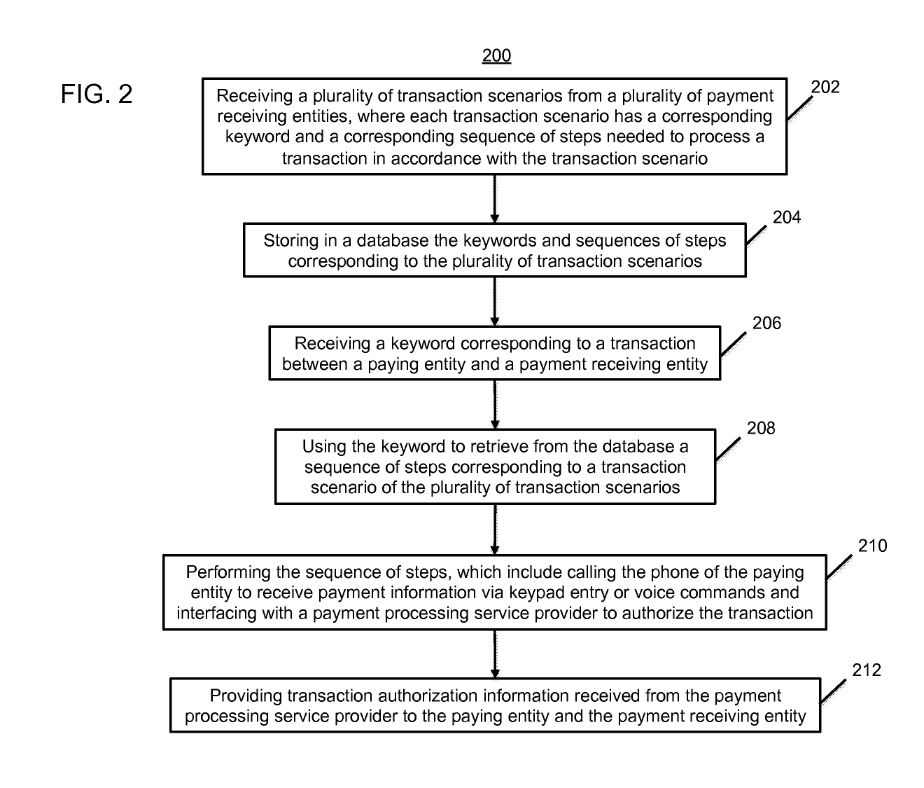

FIG. 2 depicts an exemplary method 200 for managing a transaction using a transaction server 102. Referring to FIG. 2, the method 200 comprises six parts 202-212. A first part 202 of the method 200 involves a transaction server 102 receiving a plurality of transaction scenarios from a plurality of payment receiving entities 106, where each transaction scenario has a corresponding keyword and a corresponding sequence of steps needed to process a transaction in accordance with the transaction scenario. A second part 204 of the method 200 involves storing the keywords and sequences of steps to be performed by the transaction server corresponding to the plurality of transaction scenarios in a database 104. A third part 206 of the method 200 involves receiving a keyword corresponding to a transaction between a paying entity 108 and a payment receiving entity 106. A fourth part 208 of the method 200 involves using the keyword to retrieve from the database 104 a sequence of steps corresponding to a transaction scenario of the plurality of transaction scenarios. A fifth part 210 of the method 200 involves the transaction server 102 performing the sequence of steps, which include calling the phone of a paying entity 108 to receive payment information via keypad entry or voice commands and interfacing with a payment processing service provider 112 to authorize the transaction, and a sixth part 212 of the method 200 involves providing transaction authorization information received from the payment processing service provider 112 to the paying entity 108 and the payment receiving entity 106.

While particular embodiments of the invention have been described, it will be understood, however, that the invention is not limited thereto, since modifications may be made by those skilled in the art, particularly in light of the foregoing teachings.

1. A system for managing payment transactions, comprising:
a data storage; and
a transaction server, said transaction server being configured to:
receive a plurality of transaction scenarios from a plurality of payment receiving entities, wherein each transaction scenario of said plurality of transaction scenarios has a corresponding keyword and a corresponding sequence of steps needed to process a transaction in accordance with the transaction scenario;
store in said data storage the keywords and respective sequences of the steps to be performed by the transaction server corresponding to the plurality of transaction scenarios;
receive a keyword corresponding to a transaction between a paying entity and a payment receiving entity;
use the keyword to retrieve from the database a sequence of steps corresponding to a transaction scenario of the plurality of transaction scenarios;
perform the sequence of steps including calling the phone of the paying entity to receive payment information via keypad entry or voice commands and interfacing with a payment processing service provider to authorize the transaction; and
provide transaction authorization information received from the payment processing service provider to the paying entity and the payment receiving entity.

2. The system of claim 1, wherein a given sequence of steps to be performed by the transaction server corresponding to a given transaction scenario of said plurality of transaction scenarios can be different than another sequence of steps to be performed by the transaction server corresponding to different transaction scenario of said plurality of transaction scenarios.

3. The system of claim 1, wherein a payment receiving entity of a plurality of payment receiving entities determines the sequence of steps to be performed by the transaction server corresponding to a given transaction scenario of said plurality of transaction scenarios.

4. The system of claim 1, wherein a payment receiving entity of a plurality of payment receiving entities determines the keyword corresponding to a given transaction scenario of said plurality of transaction scenarios.

5. The system of claim 1, wherein the user receives at least one of a short code or the keyword via a mail, an email, a fax, a text message, a voice message, an advertisement, or the Internet.

6. The system of claim 1, wherein said keyword is provided by the user to a short code service provider that provides the keyword to the transaction server.

7. The system of claim 1, wherein said keyword is provided by the user to the payment receiving entity that provides the keyword to the transaction server.

8. The system of claim 1, wherein said keyword is provided by the user directly to the transaction server.

9. The system of claim 1, wherein said payment information is received from the user by said transaction server in response to recorded voice prompts, live voice prompts, synthesized voice prompts, or displayed text directed to the keypad on the phone of the paying entity.

10. The system of claim 1, wherein said payment receiving entity is one of a restaurant, a theme park, an attraction, an exposition, a conference, a traveling show, a concert, a live entertainment, a sporting event, a hotel, a resort, a theater, a taxi, a municipality, a government, an online-store, a charity or a non-profit organization.

11. A method for managing payment transactions using a transaction server and a data storage, comprising:
receiving by said transaction server a plurality of transaction scenarios from a plurality of payment receiving entities, wherein each transaction scenario of said plurality of transaction scenarios has a corresponding keyword and a corresponding sequence of steps needed to process a transaction in accordance with the transaction scenario;
storing in said data storage the keywords and respective sequences of the steps to be performed by the transaction server corresponding to the plurality of transaction scenarios;
receiving a keyword corresponding to a transaction between a paying entity and a payment receiving entity;
using the keyword to retrieve from the database a sequence of steps corresponding to a transaction scenario of the plurality of transaction scenarios;
performing the sequence of steps including calling the phone of the paying entity to receive payment information via keypad entry or voice commands and interfacing with a payment processing service provider to authorize the transaction; and
providing transaction authorization information received from the payment processing service provider to the paying entity and the payment receiving entity.

12. The method of claim 11, wherein a given sequence of steps to be performed by the transaction server corresponding to a given transaction scenario of said plurality of transaction scenarios can be different than another sequence of steps to be performed by the transaction server corresponding to different transaction scenario of said plurality of transaction scenarios.

13. The method of claim 11, wherein a payment receiving entity of a plurality of payment receiving entities determines the sequence of steps to be performed by the transaction server corresponding to a given transaction scenario of said plurality of transaction scenarios.

14. The method of claim 11, wherein a payment receiving entity of a plurality of payment receiving entities determines the keyword corresponding to a given transaction scenario of said plurality of transaction scenarios.

15. The method of claim 11, wherein the user receives at least one of a short code or the keyword via a mail, an email, a fax, a text message, a voice message, an advertisement, or the Internet.

16. The method of claim 11, wherein said keyword is provided by the user to a short code service provider that provides the keyword to the transaction server.

17. The method of claim 11, wherein said keyword is provided by the user to the payment receiving entity that provides the keyword to the transaction server.

18. The method of claim 11, wherein said keyword is provided by the user directly to the transaction server.

19. The method of claim 11, wherein said payment information is received from the user by said transaction server in response to recorded voice prompts, live voice prompts, synthesized voice prompts, or displayed text directed to the keypad on the phone of the paying entity.

20. The method of claim 11, wherein said payment receiving entity is one of a restaurant, a theme park, an attraction, an exposition, a conference, a traveling show, a concert, a live entertainment, a sporting event, a hotel, a resort, a theater, a taxi, a municipality, a government, an online-store, a charity or a non-profit organization.
